(19) United States
(12) Patent Application Publication
(10) Pub. No.: US 2005/0246989 A1
(43) Pub. Date: Nov. 10, 2005

(54) Backsplash assembly and method

(76) Inventors: David L. Pringle, Waukesha, WI (US); Kenneth J. Jonas, Mequon, WI (US); Donovan M. Gehring, West Bend, WI (US); Christopher J. Nemacheck, Sussex, WI (US); Karen J. Formico, Mequon, WI (US)

Correspondence Address: MICHAEL BEST & FRIEDRICH, LLP, 100 E WISCONSIN AVENUE, MILWAUKEE, WI, 53202, US

(21) Appl. No.: 10/817,149

(22) Filed: Apr. 2, 2004

(51) Int. Cl. B08B 3/00; B08B 6/00; B08B 3/12; E04F 13/08

(52) U.S. Cl. 52/384; 52/390

(57) ABSTRACT

Some embodiments of the present invention provide a backsplash for protecting a first surface adjacent a work surface. In some embodiments, the backsplash includes a layer of tiles having a front surface exposed and resistant to byproducts of work performed on the work surface. In some embodiments, the layer of tiles are coupled together for installation and removal from the first surface as a single integral unit. Also, in some embodiments the backsplash includes a mount positioned to releasably and removably couple the backsplash to the first surface in at least one location between the backsplash and the first surface. The mount can retain the layer of tiles in a substantially perpendicular relationship with respect to the work surface when the backsplash is in the mounted position upon the first surface. Also, some embodiments of the present invention provide a method of releaseably coupling a backsplash to a first surface adjacent a work surface.

### BACKGROUND OF THE INVENTION

In kitchens, bathrooms, and other environments, it is often desirable to protect surfaces adjacent work surfaces from byproducts of work performed on such work surfaces and from other damage. Also, it is often desirable to maintain a pleasing appearance for surfaces adjacent work surfaces. Examples of work surfaces include sinks, ranges, countertops, grills, and the like—any of which can expose adjacent surfaces to liquid splatter, steam, and other fluids, smoke, grease, food, heat, and other elements. Such elements can contact or otherwise be exposed to an adjacent surface, can create an unpleasant appearance of the adjacent surface, can create material build-up on the adjacent surface, and can damage the adjacent surface over time.

In attempts to address these issues, permanent tile or other material (e.g., stainless steel sheeting, plastic or synthetic panels, and the like) is often connected to surfaces adjacent work surfaces for increased cleanability and to protect surfaces behind the permanent tile or other material. Typically, such tile or other material is permanently mounted to the adjacent surface by nailing or bonding, thereby making removal of the permanently mounted tile or other permanently-mounted material difficult and timely. In addition, the permanently mounted tile or other permanently mounted material are often damaged when removed, are often not re-usable, and can cause damage to the adjacent surface when removed therefrom. Over time, the permanently-mounted tile or other permanently mounted material can have an unpleasant appearance due to material build-up, staining, or other damage, and may need to be replaced. Replacement of permanent tiles or other permanent material on a surface is an intensive process and can be somewhat expensive.

In addition, permanent tile and other permanent material used to protect surfaces adjacent work surfaces cannot be easily changed to accommodate changing styles, designs, and tastes. The intensive and expensive process of replacing the permanent tile or other permanently-mounted material must be followed to meet such changing needs.

### SUMMARY OF THE INVENTION

Some embodiments of the present invention provide a backsplash for protecting a first surface adjacent a work surface substantially perpendicular to the first surface, wherein the backsplash comprises: a layer of tiles having a front surface exposed and resistant to byproducts of work performed on the work surface when the backsplash is in a mounted position upon the first surface, the layer of tiles coupled together for installation and removal from the first surface as a single integral unit; and a mount positioned to releasably and removably couple the backsplash to the first surface in at least one location between the backsplash and the first surface, the mount retaining the layer of tiles in a substantially perpendicular relationship with respect to the work surface when the backsplash is in the mounted position upon the first surface.

In some embodiments, a backsplash for protecting a first surface adjacent a work surface substantially perpendicular to the first surface is provided, and comprises: a layer of protective material having a front surface exposed and resistant to byproducts of work performed on the work surface when the backsplash is in a mounted position upon the first surface; a first mount on a rear of the backsplash; and a second mount adapted to be coupled to the first surface, the first mount releasably coupled to the second mount to removably support the layer of protective material upon the first surface in an orientation substantially perpendicular to the work surface, wherein the first and second mounts are shaped to retain the layer of protective material against the first surface when the first mount is coupled to the second mount.

Some embodiments of the present invention provide a method of releasably coupling a backsplash to a first surface adjacent a work surface substantially perpendicular to the first surface, comprising: mounting a first mount to the first surface; releasably coupling a second mount on the back of the backsplash to the first mount; drawing the backsplash to a substantially flush position against the first surface by coupling the second mount to the first mount; and releasably supporting the backsplash upon the first mount in a substantially perpendicular orientation with respect to the work surface.

Further objects and advantages of the present invention, together with the organization and manner of operation thereof, will become apparent from the following detailed description of the invention when taken in conjunction with the accompanying drawings, wherein like elements have like numerals throughout the drawings.

### BRIEF DESCRIPTION OF THE DRAWINGS

In the drawings, wherein like reference numerals indicate like parts:

FIG. 1 is a front perspective view of a backsplash according to an embodiment of the present invention, shown with surrounding environment;

FIG. 2 is an exploded front perspective view of the backsplash shown in FIG. 1;

FIG. 3 is a partial cross-sectional view of the backsplash shown in FIG. 1;

FIG. 4 is an exploded front perspective view of a backsplash according to another embodiment of the present invention;

FIG. 5 is a partial cross-sectional view of the backsplash shown in FIG. 4;

FIG. 6 is an exploded front perspective view of a backsplash according to another embodiment of the present invention;

FIG. 7 is an exploded front perspective view of a backsplash according to another embodiment of the present invention;

FIG. 8 is a partial cross-sectional view of the backsplash shown in FIG. 7;

FIG. 9 is an exploded rear perspective view of a backsplash according to another embodiment of the present invention;

FIG. 10 is an enlarged, partial, front perspective view of the backsplash shown in FIG. 9;

FIG. 10A is a detail side view of a wall mount of the backsplash shown in FIG. 9;

FIG. 10B is a detail side view an alternative wall mount according to the present invention;

FIG. 11 is an exploded, partial, rear perspective view of a backsplash according to yet another embodiment of the present invention; and

FIG. 12 is a front view of a template employed to determine a mounting orientation for a backsplash according to the present invention.

Before the various embodiments of the present invention are explained in detail, it is to be understood that the invention is not limited in its application to the details of construction and the arrangements of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

### DETAILED DESCRIPTION

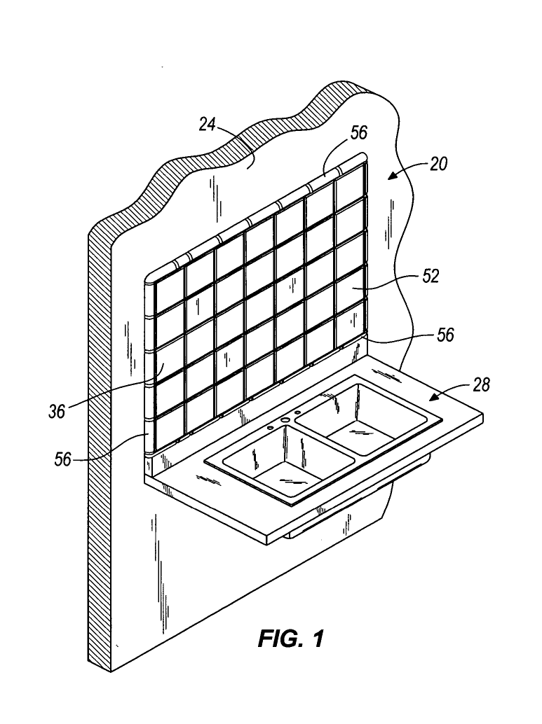

With reference to FIG. 1, a backsplash 20 according to an embodiment of the present invention is shown installed adjacent a work surface 28, such as a work surface of a kitchen or bathroom. Although a sink is shown as the work surface in FIG. 1, the backsplash 20 can instead be mounted adjacent any other work surface 28. As used herein and in the appended claims, the term “work surface” includes any other elevated kitchen or bathroom surface upon which work is performed and/or items can be supported, including without limitation without a range, countertop, grill, cutting board, shelf, and the like. In some embodiments, such a work surface is a surface at countertop height in a kitchen or bathroom.

In the illustrated embodiment of FIG. 1, the backsplash 20 is coupled to a wall 24. However, the backsplash 20 of the present invention can be coupled to any other surface desired. Accordingly, the backsplash 20 illustrated in FIG. 1 is shown coupled to a wall by way of example only.

With continued reference to FIG. 1, the backsplash 20 is positioned upon a wall 24 at a higher elevation than the adjacent work surface 28, and in a perpendicular or substantially perpendicular relationship with respect to the work surface 28. However, in other embodiments, a space can exist between the work surface 28 and the backsplash 20. Also, depending at least in part upon the orientation of the wall 24 upon which the backsplash 20 is positioned, the backsplash 20 can be oriented differently with respect to the work surface 28.

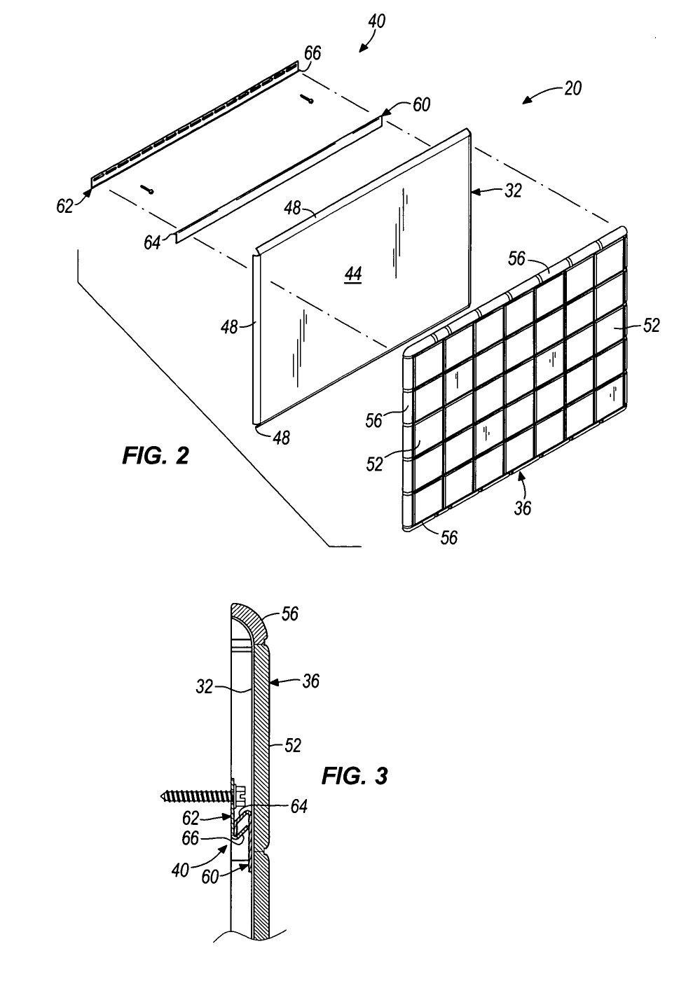

As shown in FIG. 2, the backsplash 20 includes a support 32, a protective layer 36 coupled to the support 32, and a coupling assembly 40. In some embodiments, the protective layer comprises material or materials that are resistant to fluid, heat, and/or other byproducts of work performed on the work surface (e.g., steam, grease, smoke, detergents and cleaning solvents, and the like). The protective layer 36 can be permanently mounted to the support 32 in any manner, such as by adhesive or cohesive material, tile setting material, mortar, rivets, nails, and other conventional fasteners, and the like. Depending at least in part upon the material of the protective layer 36, in some embodiments the protective layer 36 is welded, brazed, soldered, or crimped to the support 32. In other embodiments, the protective layer 36 can be releasably mounted to the support 32, such as by pegs, screws, clamps, clips, brackets, inter-engaging elements, and the like. By way of example only, the protective layer in the illustrated embodiments of FIGS. 1-12 is a layer of tiles mounted upon the support 32. Because the backsplash 20 is removably mounted to the wall 24 as described in greater detail below, such mounting enables the tiles 36 to be installed and removed from the wall 24 as a single integral unit. In other embodiments, the tiles 36 can define a panel that is not mounted upon a support 32 as just described. For example, the tiles 36 can be connected along their sides in any manner described above.

The support 32 (if employed) can be any element or assembly of elements over or upon which the protective layer 36 is coupled for supporting the protective layer 36. For example, the support 32 can be a substantially planar sheet of metal, wood, fiberglass, plastic or other synthetic material, ceramic, glass, and the like, and any combinations of such materials.

In the illustrated embodiment of FIGS. 1-3, the support 32 has a substantially flat portion 44 and curved edges 32 that curve toward a rear of the backsplash 20 and in the direction of the wall 24 to which the backsplash 20 will be coupled. In other embodiments, the edges 32 can curve in an opposite direction, can be bent or otherwise angled in either direction, or can be substantially flat and co-planar with the flat portion 44. The layer of tiles 36 in the illustrated embodiment of FIGS. 1-3 includes a front surface 52, can include curved edges 56 as illustrated, or can have edges of other shapes (e.g., edges that are bezeled, chamfered, faceted, and the like). If desired, the edges 56 can be shaped to complement the curved or angled edges 48 of the support 32.

With reference to FIGS. 2 and 3, the coupling assembly 40 enables the backsplash 20 to be releasably coupled to the wall 24. Once the coupling assembly 40 has been mounted to the wall 24 as described in greater detail below, the backsplash 20 can be easily removed from the wall 24 by a user. In some embodiments (such as the embodiment of FIGS. 1-3), the coupling assembly 40 enables installation of the backsplash 20 upon the wall 24 and removal of the backsplash 20 from the wall 24 without the use of tools.

In the illustrated embodiment of FIGS. 1-3, the coupling assembly 40 includes a support mount 60 and a wall mount 62. The support mount 60 and wall mount 62 can be any size and shape capable of providing at least one connection location between the support mount 60 and wall mount 62. In the illustrated embodiment of FIGS. 1-3 for example, the support and wall mounts 60, 62 are both substantially elongated elements.

The support mount 60 is coupled to a rear of the support 32 and the wall mount 62 is adapted to be coupled to the wall 24. The support mount 60 and the wall mount 62 can be coupled to the support 32 and the wall 24, respectively, in a variety of different manners. In the illustrated embodiment for example, the support mount 60 is coupled to the support 32 by adhesive or cohesive bonding material, and the wall mount 62 is adapted to be coupled to the wall 24 by conventional fasteners (e.g., screws, rivets, bolts, nails, and the like). If desired, the support mount 60 can be integral with the support 32. In other embodiments, the support mount 60 can be coupled to the support and the wall mount 62 can be coupled to the wall 24 in any other manner, including any of the manners described above for coupling the protective layer 36 to the support 32. The manner in which the mounts 60, 62 are mounted can depend at least partially upon the type of material(s) used for the support 32 and the material of the wall 24.

The support mount 60 can alternatively be directly or indirectly coupled to the layer of tiles 36 or other protective layer 36 in embodiments in which a support 32 is not employed. Also, the wall mount 62 can alternatively be mounted to an intermediate component (not shown) which is itself mounted to the wall 24.

In some embodiments, the support mount 60 and the wall mount 62 are shaped to draw the backsplash 20 toward the wall 24 upon engagement of the support mount 60 and wall mount 62 (i.e., as the support and wall mounts 60, 62 are coupled together). In this manner, the backsplash 20 can be drawn to a desired position with respect to the wall 24, such as in a substantially flush position against the 24. In the illustrated embodiment of FIGS. 1-3 for example, the support mount 60 has a downturned flange 64 and the wall mount 62 includes an upturned flange 66 engageable with the downturned flange 64 to releaseably and removably couple the backsplash 20 to the wall 24 and to support the backsplash 20 in position upon the wall 24. In this embodiment, the downturned flange 64 and the upturned flange 66 extend a substantial length of the support mount 60 and the wall mount 62, respectively. However, it will be appreciated that the downturned and upturned flanges 64, 66 can extend any length of the support mount 60 and the wall mount 62, respectively, and that the support mount 60 and the wall mount 62 can include any number of downturned and upturned flanges 60, 62, respectively, engageable with each other to releaseably and removably couple the backsplash 20 to the wall 24. For example, the support and/or wall mounts 60, 62 can have flanges 60, 62 that define points at which the support and wall mounts 60, 62 are releasably coupled as described above, areas along the backsplash 20 along which the support and wall mounts 60, 62 are releasably coupled as described above, and the like.

As described above, the support and wall mounts 60, 62 have upturned and downturned flanges 64, 66, respectively, that function to draw the backsplash 20 toward the wall 24 (as well as to couple the support and wall mounts 60, 62 together and to support the weight of the backsplash 20 upon the wall 24). In some embodiments, the flanges 64, 66 have surfaces that are inclined or curved to contact one another as the support and wall mounts 60, 62 are coupled together. Such surfaces can be defined along a substantial portion or all of either or both mounts 60, 62, as shown in the FIGS. 1-3 embodiment (e.g., along the flanges 64, 66 of the illustrated mounts 60, 62) or at one or more points or areas along the mounts 60, 62 (e.g., at inclined or curved surfaces of flanges, projections or other features of the mounts 60, 62, and the like).

In the illustrated embodiment of FIGS. 1-3, the backsplash 20 is mounted to the wall 24 by first mounting the wall mount 62 to the wall 24 with fasteners, although the other manners described above for mounting the wall mount 62 can instead be employed. The support mount 60, support 32, and the tiles 36 are then lifted and moved near the wall mount 62 until the downturned flange 64 of the support mount 60 is positioned above the upturned flange 66 of the wall mount 62. The support mount 60, the support 32, and the tiles 36 are then moved downwardly until the downturned flange 64 of the support mount 60 engages the upturned flange 66 of the wall mount 62. The upturned and downturned flanges 64, 66 are shaped to cause the downturned flange 64 to slide or cam rearwardly along the upturned flange 66, thereby causing the backsplash 20 to move toward the wall 24. In some embodiments, this movement stops when a rear surface of the backsplash 20 is against the wall 24 (such as in a flush position against the wall 24) and/or when the downturned flange 64 is near or at the lowest location of the upturned flange 66 (see FIG. 3). The backsplash 20 is then releaseably and removably coupled to the wall 24. To remove the backsplash 20, the support mount 60, the support 32, and the tiles 36 are lifted until the downturned flange 64 disengages the upturned flange 66 and the support mount 60. The support 32 and the tiles 36 can then be moved away from the wall mount 62.

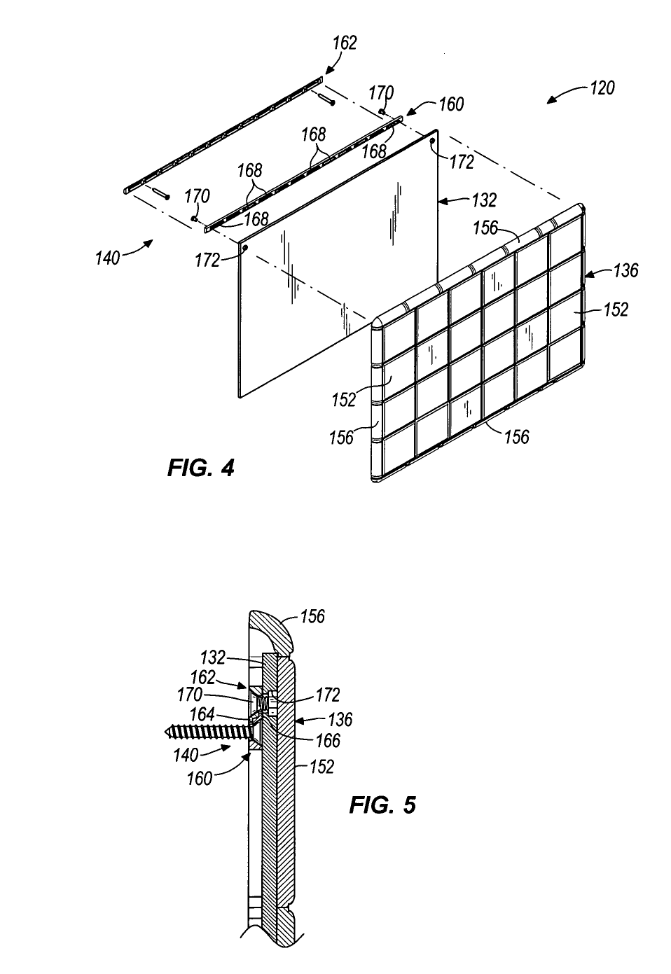

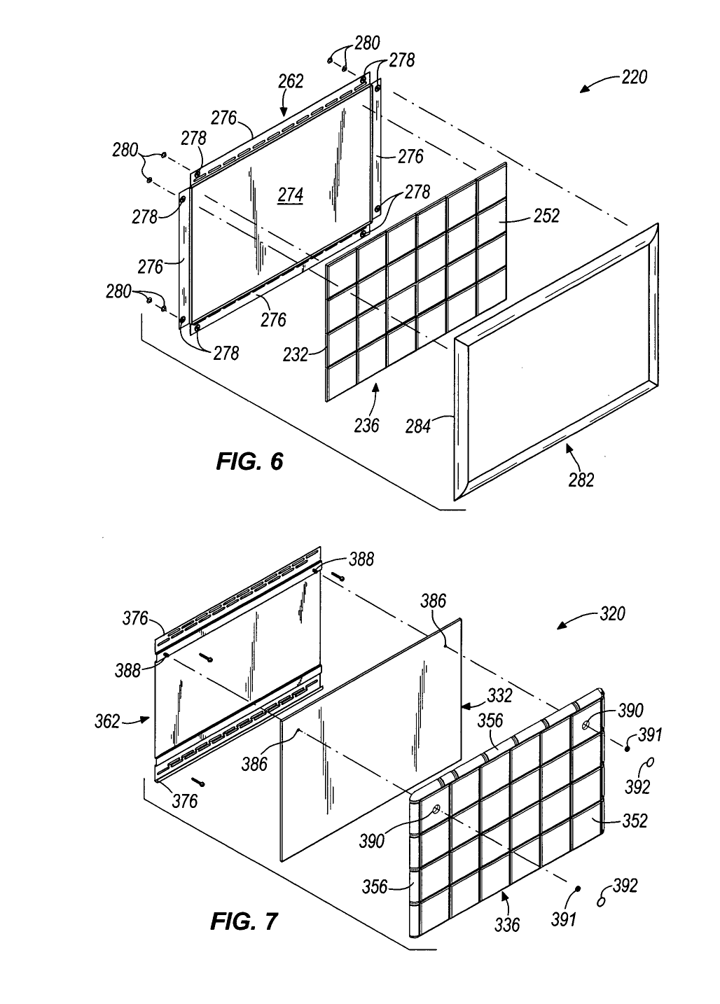

With reference to FIGS. 4 and 5, an alternative embodiment of the backsplash according to the present invention is shown. The backsplash 120 shown in FIGS. 4 and 5 is similar in many ways to the backsplash 20 described above with reference to FIGS. 1-3. Accordingly, with the exception of mutually inconsistent features and elements between the backsplash of FIGS. 4 and 5 and those described above with reference to FIGS. 1-3, reference is hereby made to the description above accompanying the embodiment of FIGS. 1-3 for a more complete description of the features and elements (and the alternatives to the features and elements) of the backsplash of FIGS. 4 and 5. Features and elements of the backsplash of FIGS. 4 and 5 corresponding to features and elements of the backsplash 20 of FIGS. 1-3 are numbered in the 100 series.

The support mount 160 illustrated in FIGS. 4 and 5 employs fasteners 170 to mount the support mount 160 to the support 132. Although any type of fasteners can be employed, the embodiment of FIGS. 4 and 5 has threaded fasteners 170 passed through apertures 168 in the support mount 160 and through or into apertures 172 in the support 132. In other embodiments, such threaded fasteners can instead be integral with the support mount 160 or the support 132. The threaded fasteners 170 can secure the support mount 160 to the support by being threaded into threads of the support apertures 172 and/or by nuts threaded on the fasteners 170 as shown in FIG. 5 (in which case the nuts can be recessed in the support 132, if desired).

The wall mount 162 in FIGS. 4 and 5 has a plurality of apertures through which fasteners can be inserted to couple the wall mount 162 to the wall 124. The support mount 160 is engageable with the wall mount 162 to releaseably and removably couple the backsplash 120 to the wall 124. In the illustrated embodiment, the support mount 160 includes a downturned flange 164 and the wall mount 162 includes an upturned flange 166 engageable with the downturned flange 164 to releaseably and removably couple the backsplash 120 to the wall 124. As discussed above, the support mount 160 and the wall mount 162 can be configured in a variety of different manners for releasable engagement with one another to releaseably and removably couple the backsplash 120 to the wall 124.

With reference to FIG. 6, an alternative embodiment of the backsplash according to the present invention is shown. The backsplash 220 shown in FIG. 6 is similar in many ways to the backsplashes 20, 120 described above with reference to FIGS. 1-5. Accordingly, with the exception of mutually inconsistent features and elements between the backsplash of FIG. 6 and those described above with reference to FIGS. 1-5, reference is hereby made to the description above accompanying the embodiments of FIGS. 1-5 for a more complete description of the features and elements (and the alternatives to the features and elements) of the backsplash 220 of FIG. 6. Features and elements of the backsplash 220 of FIG. 6 corresponding to features and elements of the backsplashes 20, 120 of FIGS. 1-5 are numbered in the 200 series.

The support 232 of the backsplash 220 illustrated in FIG. 6 (shown connected to the layer of tiles 236) is substantially flat and is similar in size to and substantially covered by the layer of tiles 236. As described above, in some embodiments a support 232 is not used, in which case the tiles 236 can be mounted directly to the wall mount 262. The wall mount 262 includes a planar portion 274 engageable by the support 232 and flanges 276 extending from each edge of the wall mount 262 (although any number of such flanges 276 extending from any number of the wall mount edges can be employed). The top and bottom flanges 276 of the wall mount 262 have a plurality of apertures therethrough for receiving fasteners (not shown) for coupling the wall mount 262 to the wall 24. Each flange 276 also defines apertures 278 therethrough for receiving frame fasteners 280. The illustrated backsplash 20 also includes a frame 282 that can be releaseably and removably coupled to the wall mount 262 by the frame fasteners 280, which can be inserted through the apertures 278 defined in the flanges 276 and into frame apertures (not shown) defined in a rear surface 284 of the frame 282. In some constructions, the frame fasteners 280 are press fit, snap fit, or are otherwise shaped to be received within the frame apertures to releaseably and removably couple the frame 282 to the wall mount 262. In other embodiments, one or more fasteners (not shown) can be passed through apertures in a front of the frame 282 and into the wall mount 262, in which case the apertures in the front of the frame 282 can be plugged or otherwise covered in any suitable manner, if desired.

When coupled to the wall mount 262, the frame 282 surrounds the edges of the tiles 236 and the support 232. In some embodiments, the frame 282 can also trap the edges 236 of the tiles 236 and/or support 232 against the wall mount 262. In such cases, the frame 282 can retain the tiles 236 and/or support 232 in place upon the wall mount 262 (if not secured thereto in another manner). Also, the frame 282 can be shaped to cover the flanges 276 or edges of the wall mount 262 in order to hide the wall mount 262 from view.

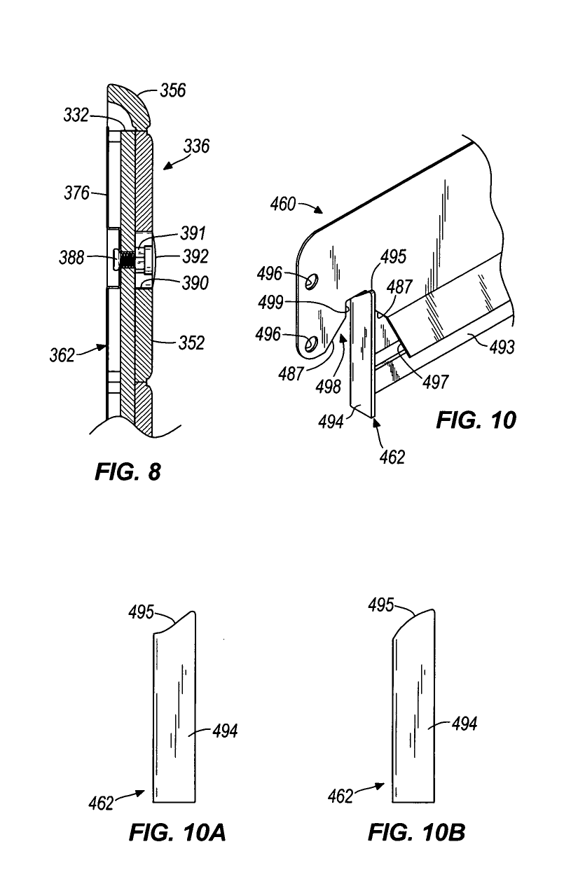

With reference to FIGS. 7 and 8, an alternative embodiment of the backsplash 20 is shown. The backsplash 20 shown in FIGS. 7 and 8 is similar in many ways to the backsplash 20 described above with reference to FIGS. 1-6. Accordingly, with the exception of mutually inconsistent features and elements between the backsplash 20 embodiments of FIGS. 1-6 and FIGS. 7 and 8, reference is hereby made to the description above accompanying the embodiments of FIGS. 1-6 for a more complete description of the features and elements (and the alternatives to the features and elements) of the backsplash 20 embodiment of FIGS. 7 and 8. Features and elements of the backsplash 20 of FIGS. 7 and 8 corresponding to features and elements of the embodiments of FIGS. 1-6 are numbered in the 300 series.

With reference to FIGS. 7 and 8, an alternative embodiment of the backsplash according to the present invention is shown. The backsplash 320 shown in FIGS. 7 and 8 is similar in many ways to the backsplashes 20, 120, 220 described above with reference to FIGS. 1-6. Accordingly, with the exception of mutually inconsistent features and elements between the backsplash of FIGS. 7 and 8 and those described above with reference to FIGS. 1-6, reference is hereby made to the description above accompanying the embodiments of FIGS. 1-6 for a more complete description of the features and elements (and the alternatives to the features and elements) of the backsplash 320 of FIGS. 7 and 8. Features and elements of the backsplash 320 of FIGS. 7 and 8 corresponding to features and elements of the backsplashes 20, 120, 220 of FIGS. 1-6 are numbered in the 300 series.

The backsplash 320 according to the embodiment illustrated in FIGS. 7 and 8 does not employ a support mount, and is instead secured to a wall mount 362 in another manner described below. The support 332 of the backsplash 320 in FIGS. 7 and 8 is substantially planar and includes support apertures 386 defined therein. The wall mount 362 includes flanges (e.g., top and bottom flanges 376) that each include apertures therein for receiving fasteners for coupling the wall mount 362 to the wall 324. The wall mount 362 also includes studs 388 that project from the front of the wall mount 362. The support 332 and tiles 336 can be releaseably and removably coupled to the wall mount 362 by inserting the studs 388 through the support apertures 386 and apertures 390 in the layer of tiles 336. Complementary fasteners (such as threaded nuts or other fasteners) can be used to engage the end of the studs 388 in order to couple the wall mount 362, the support 332, and the tiles 336 together. In alternative embodiments, other types of fasteners can be inserted through the apertures 390, 386 in the layer of tiles 336 and the support 332 for engagement with the wall mount 362 in any suitable manner. For example, screws can be passed through the apertures 390, 386 in the layer of tiles 336 and the support 332 and can be passed into threaded apertures in the wall mount 362 or can be secured within apertures in the wall mount 362 by nuts. Other types of fasteners received through apertures in the layer of tiles 336 and the support 332 for connection to the wall mount 362 are possible, and fall within the spirit and scope of the present invention.

If desired, a decorative cap 392 can be inserted into each of the tile apertures 390 described above to cover the tile apertures 390 and the fastener therein in order to provide a substantially flat and aesthetically pleasing front surface of the tiles 336. In the illustrated embodiment of FIGS. 7 and 8, the studs 388 are threaded, and the complementary fasteners 391 are threaded nuts that threadably engage the studs 388 to couple the wall mount 362, the support 332, and the tiles 336 together. In some constructions, the studs 388 and the complementary fasteners 391 can be press-fit or snap-fit together or can be connected together in any other manner to couple the wall mount 362, the support 332 and the tiles 336 together.

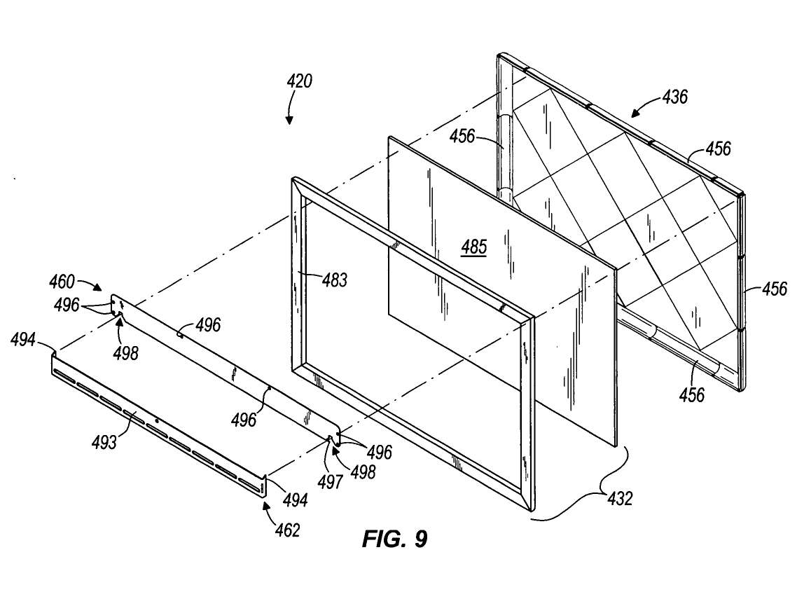

With reference to FIGS. 9 and 10, an alternative embodiment of the backsplash according to the present invention is shown. The backsplash 420 shown in FIGS. 9 and 10 is similar in many ways to the backsplashes 20, 120, 220, 320 described above with reference to FIGS. 1-8. Accordingly, with the exception of mutually inconsistent features and elements between the backsplash of FIGS. 9 and 10 and those described above with reference to FIGS. 1-8, reference is hereby made to the description above accompanying the embodiments of FIGS. 1-8 for a more complete description of the features and elements (and the alternatives to the features and elements) of the backsplash 420 of FIGS. 9 and 10. Features and elements of the backsplash 420 of FIGS. 9 and 10 corresponding to features and elements of the backsplashes 20, 120, 220, 320 of FIGS. 1-8 are numbered in the 400 series.

The wall mount 462 in the embodiment of FIGS. 9 and 10 includes a back plate 493, a projection (e.g., a flange 494) extending forwardly from each end of the back plate 493, and a plurality of apertures for receiving fasteners for coupling the wall mount 462 to the wall 424. Any number of flanges 494 extending from any part of the wall mount 462 can be employed as desired. In the embodiment of FIGS. 9 and 10, the flanges 494 can be bent or otherwise shaped from the ends of the wall mount 462, such as from a flat piece of metal or other suitable material.

The flanges 494 of the wall mount 462 can each include an angled surface 495 that extends upwardly away from the back plate 493. In some embodiments, at least part of this angled surface 495 is arcuate (e.g., having a convex profile as best shown in FIG. 10A or having a concave profile as best shown in FIG. 10B). However, in other embodiments, this angled surface 495 is substantially straight. In addition, different combinations of shapes can be provided on the same surface 495, as desired.

The shape of the flange surface 495 can provide desired mounting characteristics for the backsplash 420. This is also true for flanges and other projections employed in the earlier-described embodiments of the present invention. For example, the curved flange surface 495 illustrated in FIG. 10A can provide the support mount 460 with a degree of pivoting motion with respect to the wall mount 462—a feature that can be helpful in removing the backsplash 420 from the wall. As another example, the curved flange 495 illustrated in FIG. 10B can generate the opposite result—wedging the support mount 460 in the wall mount 462 for a tighter connection between the mounts 460, 462.

The support mount 460 illustrated in FIGS. 10A and 10B has a plurality of apertures 496 for receiving fasteners to couple the support mount 460 to the support 432 of the backsplash 420. In some embodiments, the support mount 460 includes a forwardly extending flange 497 and/or apertures 498 for releasable engagement with the wall mount 462. Any number of forwardly extending flanges 497 and/or apertures 498 can be located anywhere along the support mount 460. For example, in the illustrated embodiment of FIGS. 9 and 10, a forwardly extending flange 497 is flanked by apertures 498 located near the ends of the support mount 460. The apertures 498 are dimensioned to receive the flanges 494 of the wall mount 462. In some embodiments, the apertures 498 each have an upper portion 499 and one or more edges 487 angled toward the upper portion 499.

In the illustrated embodiment, the support 432 has a substantially planar portion 485 and a support frame 483 coupled to and surrounding the edges of the substantially planar portion 485. In other embodiments, the support 432 is a single integral piece (wherein the substantially planar portion 485 and the frame 483 are integral with one another).

To mount the backsplash 420 of FIGS. 9 and 10 to a wall 424, the wall mount 462 is first coupled to the wall 24 with fasteners passed through apertures in the wall mount 462 or in any of the other manners described above with reference to the earlier embodiments. The support mount 460, the support 432, and the tiles 436 are then brought near to the wall mount 462, and the apertures 498 of the support mount 460 are aligned with the flanges 494 of the wall mount 462. The support mount 460 is then moved toward the wall mount 462 to bring the flanges 494 into contact with the support mount 460 within the apertures 498. If the flanges 494 engage the angled edges 487 of the apertures 498, the angled edges 487 can help guide the flanges 494 into the upper portions 499 of the apertures 498 upon further downward movement of the support mount 460. The flanges 494 can engage the tops of the upper portions 499 of the apertures 498 and the support mount 460. Also, the upper portions 499 of the apertures 498 can slide downwardly and rearwardly along the angled surfaces 495 of the flanges 494. This sliding or camming motion can continue until the support mount 460, the support 432, and/or the layer of tiles 436 engage the wall 424 (in which case the backsplash 20 can be brought to rest upon the wall 24 in any position, such as a flush position) or until the support mount 460 has moved as far as it can along the flanges 494 of the wall mount 462. At this point, the backsplash 20 is releaseably and removably coupled to the wall 24.

The forwardly extending flange 497 of the support mount 497 can be employed to inhibit an incorrect coupling between the support mount 460 and the wall mount 462. Specifically, if the flanges 494 are not aligned with the apertures 498 and one or more flanges 494 instead engage the forwardly extending flange 497, such flange(s) 494 will be deflected by the downwardly extending flange 497 to prevent connection between the deflected flange(s) 494 and the wall mount 462. Other features and elements of the support mount 460 and/or wall mount 462 can be employed to prevent an incorrect connection therebetween while still falling within the spirit and scope of the present invention.

To remove the backsplash 420 from the wall 424, the support mount 460, the support 432 and the tiles 436 are lifted until the flanges 494 disengage the support mount 460 and are removed from the apertures 498. At this point, the backsplash 20 is removed and uncoupled from the wall 24.

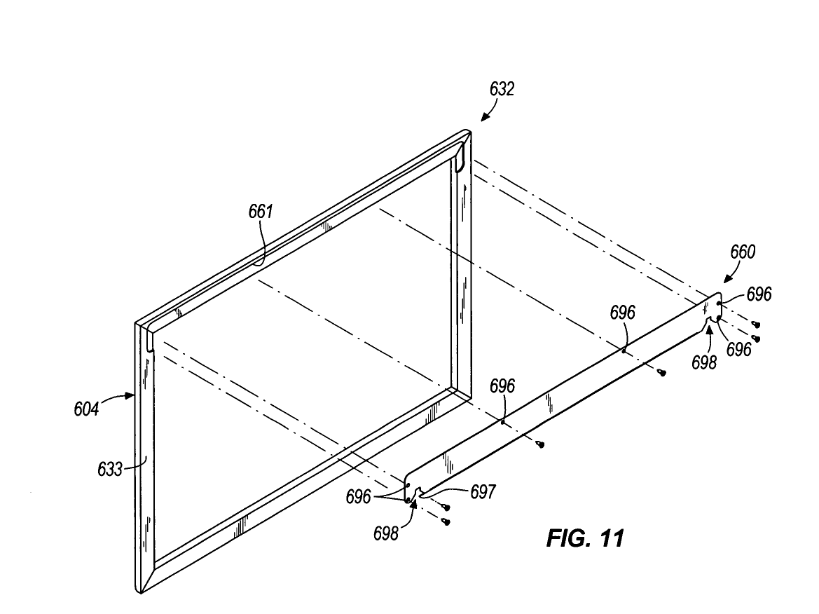

With reference to FIG. 11, an alternative embodiment of the backsplash according to the present invention is shown. The backsplash 620 shown in FIG. 11 is similar in many ways to the backsplashes 20, 120, 220, 320, 420 described above with reference to FIGS. 1-10. Accordingly, with the exception of mutually inconsistent features and elements between the backsplash of FIG. 11 and those described above with reference to FIGS. 1-10, reference is hereby made to the description above accompanying the embodiments of FIGS. 1-10 for a more complete description of the features and elements (and the alternatives to the features and elements) of the backsplash 620 of FIG. 11. Features and elements of the backsplash 620 of FIG. 11 corresponding to features and elements of the backsplashes 20, 120, 220, 320, 420 of FIGS. 1-10 are numbered in the 600 series.

In some embodiments, it is desirable to recess the support mount with respect to the backsplash, such as to prevent the support mount from protruding beyond the rear of the backsplash and possibly interfering with proper mounting or flush mounting of the backsplash against a wall. For example, the support 632 illustrated in FIG. 11 has a groove 661 in a rear surface 633 thereof for receiving the support mount 660. When positioned within the groove 661, the support mount 660 does not substantially, if at all, protrude outwardly from the rear surface 633 of the support 632. Accordingly, the support 632 can be positioned flush to a wall 624 when the backsplash 620 is coupled to the wall 624 due to the lack of interference between the support mount 660 and the wall mount 662 or the wall 624.

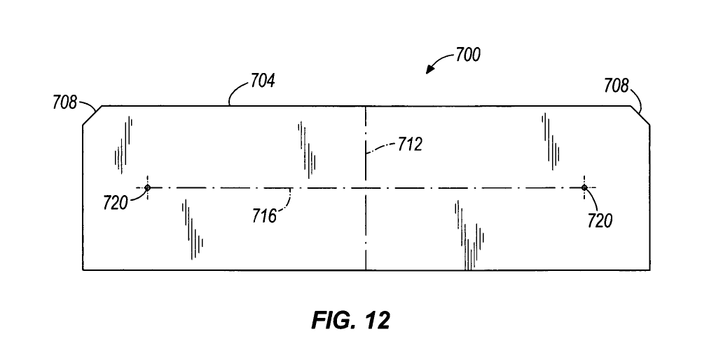

With reference to FIG. 12, a template 700 for positioning a backsplash 20, 120, 220, 320, 420, 620 relative to a wall 24, 124, 224, 324, 424, 624 and/or the work surface 28, 128, 228, 328, 428, 628 is shown. The template 700 is substantially planar, and can include a top edge 704, a pair of angled corners 708, a centerline 712, a horizontal line 716, and a pair of drilling indicators 720. In the illustrated construction, the top edge 704 of the template 700 is aligned with the bottom of an object (not shown), such as, for example a range hood, a cabinet, a ceiling, another backsplash 20, and the like, and tape or another temporary coupling device (not shown) is used at the angled corners 708 to temporarily mount the template 700 to the wall 24, 124, 224, 324, 424, 624. Holes can then be drilled through the template 700 and into the wall 24, 124, 224, 324, 424, 624 at the drilling indicators 720. After drilling, the tape or other temporary coupling device and the template 700 can be removed from the wall 24, 124, 224, 324, 424, 624. The backsplash 20, 120, 220, 320, 420, 620 can now be coupled to the wall 24, 124, 224, 324, 424, 624 in any of the above described manners or in other manners not discussed above.

It should be understood that the template 700 can have a variety of configurations for positioning the backsplash 20, 120, 220, 320, 420, 620 in a variety of environments relative to a variety of work surfaces 28, 128, 228, 328, 428, 628 and objects. For example, the template 700 can have a taller profile and have the drilling indicators spaced further from the top edge to position the backsplash 20, 120, 220, 320, 420, 620 further below an object. Also for example, the bottom edge or a side edge of the template 700 can be aligned with an object to orient the template, and ultimately the backsplash 20, 120, 220, 320, 420, 620, relative to the object.

It should also be understood that the template 700 can include any number of drilling indicators 720 necessary to provide a sufficient number of fasteners to properly mount the backsplash 20, 120, 220, 320, 420, 620 to the wall 24, 124, 224, 324, 424, 624.

The embodiments described above and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention. For example, the various embodiments (and alternatives thereto) of the present invention described above and illustrated in the figures are not mutually exclusive of one another. With the exception of features and elements that are mutually exclusive of or are inconsistent with one another, the features and elements of any of the embodiments can be employed in any of the other embodiments in any combination.

1. A backsplash for protecting a first surface adjacent a work surface substantially perpendicular to the first surface, the backsplash comprising:
a layer of tiles having a front surface exposed and resistant to byproducts of work performed on the work surface when the backsplash is in a mounted position upon the first surface, the layer of tiles coupled together for installation and removal from the first surface as a single integral unit; and
a mount positioned to releasably and removably couple the backsplash to the first surface in at least one location between the backsplash and the first surface, the mount retaining the layer of tiles in a substantially perpendicular relationship with respect to the work surface when the backsplash is in the mounted position upon the first surface.

2. The backsplash of claim 1, further comprising a support to which the layer of tiles are mounted.

3. The backsplash of claim 2, further comprising a frame shaped to receive the support.

4. The backsplash of claim 2, wherein the support is a substantially flat panel.

5. The backsplash of claim 2, wherein the support defines a groove therein for receiving the mount in recessed relationship with a rear surface of the backsplash.

6. The backsplash of claim 1, further comprising a frame shaped to receive the layer of tiles.

7. The backsplash of claim 1, wherein the mount is a first mount, the backsplash further comprising a second mount adapted to be coupled to the first surface, wherein the first mount is releasably coupled to the second mount to removably couple the backsplash to the first surface.

8. The backsplash of claim 7, wherein the first and second mounts are shaped to maintain at least part of the backsplash against the first surface.

9. The backsplash of claim 7, wherein the first and second mounts are releasably coupled to one another by at least one projection on one of the first and second mounts received within an aperture in another of the first and second mounts.

10. The backsplash of claim 9, wherein the first and second mounts are shaped to draw the backsplash toward the first surface as the first and second mounts are coupled together.

11. The backsplash of claim 7, wherein the first and second mounts are releasably coupled to one another by an upturned flange on one of the first and second mounts releasably engaged with a downturned flange in another of the first and second mounts.

12. The backsplash of claim 9, wherein the first and second mounts are shaped to draw the backsplash toward the first surface as the first and second mounts are coupled together.

13. The backsplash of claim 12, wherein at least one of the upturned and downturned flanges is has an arcuate surface engaged with a surface of another of the upturned and downturned surface as the first and second mounts are coupled together.

14. The backsplash of claim 1, wherein the tiles are resistant to at least one of heat and fluid.

15. The backsplash of claim 1, wherein the backsplash is dimensioned to be received between the work surface and a range hood located above the work surface.

16. A backsplash for protecting a first surface adjacent a work surface substantially perpendicular to the first surface, the backsplash comprising:
a layer of protective material having a front surface exposed and resistant to byproducts of work performed on the work surface when the backsplash is in a mounted position upon the first surface;
a first mount on a rear of the backsplash; and
a second mount adapted to be coupled to the first surface, the first mount releasably coupled to the second mount to removably support the layer of protective material upon the first surface in an orientation substantially perpendicular to the work surface,
wherein the first and second mounts are shaped to retain the layer of protective material against the first surface when the first mount is coupled to the second mount.

17. The backsplash of claim 16, wherein the first and second mounts are shaped to draw the layer of protective material toward the first surface as the first mount is coupled to the second mount.

18. The backsplash of claim 16, further comprising a support upon which the layer of protective material is mounted.

19. The backsplash of claim 18, further comprising a frame shaped to receive the support.

20. The backsplash of claim 16, wherein the layer of protective material comprises a layer of tiles.

21. The backsplash of claim 16, further comprising a frame shaped to receive the layer of protective material.

22. The backsplash of claim 16, wherein one of the first and second mounts comprises an upturned flange releasably engageable with a downturned flange of another of the first and second mounts.

23. The backsplash of claim 22, wherein the first and second mounts are shaped to draw the backsplash toward the first surface as the first and second mounts are coupled together.

24. The backsplash of claim 16, wherein one of the first and second mounts comprises a projection releasably engageable within an aperture in another of the first and second mounts.

25. The backsplash of claim 24, wherein the first and second mounts are shaped to draw the backsplash toward the first surface as the first and second mounts are coupled together.

26. The backsplash of claim 24, wherein the projection has a first surface engaged with a second surface at least partially defining an edge of the aperture as the first and second mounts are coupled together, at least one of the one of the first and second surfaces having an arcuate shape.

27. A method of releasably coupling a backsplash to a first surface adjacent a work surface substantially perpendicular to the first surface, the method comprising:
mounting a first mount to the first surface;
releasably coupling a second mount on the back of the backsplash to the first mount;
drawing the backsplash to a substantially flush position against the first surface by coupling the second mount to the first mount; and
releasably supporting the backsplash upon the first mount in a substantially perpendicular orientation with respect to the work surface.

28. The method of claim 27, wherein the backsplash comprises a layer of protective material.

29. The method of claim 28, wherein the protective material comprises a layer of tiles.

30. The method of claim 29, wherein the layer of tiles is resistant to at least one of heat and fluid.

31. The method claim 27, further comprising positioning the backsplash in a position between the work surface and a range hood located above the work surface.

32. The method of claim 27, wherein releasably coupling the second mount to the first mount includes releasably engaging an upturned flange of one of the first and second mounts with a downturned flange of another of the first and second mounts.

33. The method of claim 27, wherein releasably coupling the second mount to the first mount includes releasably engaging a projection of one of the first and second mounts within an aperture in another of the first and second mounts.

34. The method of claim 27, wherein drawing the backsplash includes camming an arcuate surface of one of the first and second mounts against a surface of another of the first and second mounts.
